(19) United States
(12) Patent Application Publication
(10) Pub. No.: US 2025/0383785 A1
(43) Pub. Date: Dec. 18, 2025

(54) MEMORY DEVICE AND PROGRAM OPERATION THEREOF

(71) Applicant: YANGTZE MEMORY TECHNOLOGIES CO., LTD., Wuhan (CN)

(72) Inventors: Man Hu, Wuhan (CN); Xiangnan Zhao, Wuhan (CN); Lei Guan, Wuhan (CN); Chenhui Li, Wuhan (CN)

(21) Appl. No.: 18/745,456

(22) Filed: Jun. 17, 2024

(30) Foreign Application Priority Data
Jun. 12, 2024 (CN) 202410756419.3

(51) Int. Cl. G06F 3/06

(52) U.S. Cl. CPC G06F 3/0619; G06F 3/0653; G06F 3/0679

(57) ABSTRACT

In certain aspects, a memory device includes a memory string including a drain select gate (DSG) transistor, memory cells, and a source select gate (SSG) transistor, a bit line coupled to the DSG transistors, a source line coupled to the SSG transistor, and a peripheral circuit coupled to the memory string through the bit line and the source line. The peripheral circuit is configured to, in a pre-charge period of a program operation, apply a bias voltage to at least one of the bit line or the source line. The bias voltage is determined based on a temperature associated with the memory device.

### CROSS-REFERENCE TO RELATED APPLICATIONS

This application claims the benefit of priority to Chinese Application No. 202410756419.3, filed on Jun. 12, 2024, the content of which is incorporated herein by reference in its entirety.

### BACKGROUND

The present disclosure relates to memory devices and operation methods thereof.

Flash memory is a low-cost, high-density, non-volatile solid-state storage medium that can be electrically erased and reprogrammed. Flash memory includes NOR Flash memory and NAND Flash memory. Various operations can be performed by Flash memory, such as read, program (write), and erase. For NAND Flash memory, an erase operation can be performed at the block level, and a program operation or a read operation can be performed at the page level.

### SUMMARY

In one aspect, a memory device includes a memory string including a drain select gate (DSG) transistor, memory cells, and a source select gate (SSG) transistor, a bit line coupled to the DSG transistors, a source line coupled to the SSG transistor, and a peripheral circuit coupled to the memory string through the bit line and the source line. The peripheral circuit is configured to, in a pre-charge period of a program operation, apply a bias voltage to at least one of the bit line or the source line. The bias voltage is determined based on a temperature associated with the memory device.

In some implementations, the temperature includes a first temperature and a second temperature lower than the first temperature, and the bias voltage includes a first bias voltage at the first temperature and a second bias voltage at the second temperature that is lower than the first bias voltage.

In some implementations, a difference between the first and second bias voltages is determined based on a difference between the first and second temperatures and a temperature coefficient.

In some implementations, the temperature coefficient is a constant.

In some implementations, the peripheral circuit is configured to program the memory cells in a direction from the DSG transistor to the SSG transistor, and in the pre-charge period, apply the bias voltage to the source line.

In some implementations, the peripheral circuit is further configured to, in the pre-charge period, turn on the SSG transistor.

In some implementations, the peripheral circuit is configured to program the memory cells in a direction from the SSG transistor to the DSG transistor, and in the pre-charge period, apply the bias voltage to the bit line.

In some implementations, the peripheral circuit is further configured to, in the pre-charge period, turn on the DSG transistor.

In some implementations, the peripheral circuit is further configured to obtain the temperature associated with the memory device, and determine the bias voltage based on the temperature.

In some implementations, the memory string includes a plurality of memory strings each including a DSG transistor, memory cells, and an SSG transistor, the bit line includes a plurality of bit lines coupled to the DSG transistors, respectively, and the source line is coupled to the SSG transistors.

In some implementations, the memory device is a three-dimensional (3D) NAND memory device.

In another aspect, a method for operating a memory device is provided. The memory device includes a memory string including a DSG transistor coupled to a bit line, memory cells, and an SSG transistor coupled to a source line. In a pre-charge period of a program operation, a bias voltage is applied to at least one of the bit line or the source line. The bias voltage is determined based on a temperature associated with the memory device.

In some implementations, the temperature includes a first temperature and a second temperature lower than the first temperature, and the bias voltage includes a first bias voltage at the first temperature and a second bias voltage at the second temperature that is lower than the first bias voltage.

In some implementations, a difference between the first and second bias voltages is determined based on a difference between the first and second temperatures and a temperature coefficient.

In some implementations, the temperature coefficient is a constant.

In some implementations, the memory cells are programmed in a direction from the DSG transistor to the SSG transistor, and in the pre-charge period, the bias voltage is applied to the source line.

In some implementations, in the pre-charge period, the SSG transistor is turned on.

In some implementations, the memory cells are programmed in a direction from the SSG transistor to the DSG transistor, and in the pre-charge period, the bias voltage is applied to the bit line.

In some implementations, in the pre-charge period, the DSG transistor is turned on.

In some implementations, the temperature associated with the memory device is obtained, and the bias voltage is determined based on the temperature.

In still another aspect, a system includes a memory device and a memory controller coupled to the memory device and configured to control the memory device. The memory device includes a memory string including a DSG transistor, memory cells, and an SSG transistor, a bit line coupled to the DSG transistors, a source line coupled to the SSG transistor, and a peripheral circuit coupled to the memory string through the bit line and the source line. The peripheral circuit is configured to, in a pre-charge period of a program operation, apply a bias voltage to at least one of the bit line or the source line. The bias voltage is determined based on a temperature associated with the memory device.

### BRIEF DESCRIPTION OF THE DRAWINGS

The accompanying drawings, which are incorporated herein and form a part of the specification, illustrate aspects of the present disclosure and, together with the description, further serve to explain the principles of the present disclosure and to enable a person skilled in the pertinent art to make and use the present disclosure.

FIG. 1 illustrates a schematic diagram of a memory device including peripheral circuits, according to some aspects of the present disclosure.

FIG. 2 illustrates a side view of a cross-section of a memory cell array including a NAND memory string, according to some aspects of the present disclosure.

FIG. 3 illustrates a block diagram of a memory device including a memory cell array and peripheral circuits, according to some aspects of the present disclosure.

FIG. 4 illustrates a schematic diagram of 3D NAND memory strings, according to some aspects of the present disclosure.

FIGS. 5A and 5B illustrate a waveform of word line voltages applied to a select word line in a program operation, according to some aspects of the present disclosure.

FIGS. 6A and 6B illustrate timing diagrams and channel potentials of NAND memory strings in a program operation, according to some aspects of the present disclosure.

FIGS. 7A and 7B illustrate timing diagrams and channel potentials of NAND memory strings in another program operation, according to some aspects of the present disclosure.

FIG. 8 illustrates timing diagrams of a program operation.

FIG. 9 illustrates timing diagrams of a program operation, according to some aspects of the present disclosure.

FIG. 10 illustrates timing diagrams of another program operation, according to some aspects of the present disclosure.

FIG. 11 illustrates a flowchart of a method for programming a memory device, according to some aspects of the present disclosure.

FIG. 12 illustrates a block diagram of a system having a memory device, according to some aspects of the present disclosure.

FIG. 13A illustrates a diagram of a memory card having a memory device, according to some aspects of the present disclosure.

FIG. 13B illustrates a diagram of a solid-state drive (SSD) having a memory device, according to some aspects of the present disclosure.

The present disclosure will be described with reference to the accompanying drawings.

### DETAILED DESCRIPTION

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Memory devices suffer from disturbance between adjacent word lines in program operations (a.k.a., program disturbance), especially for 3D NAND Flash memory devices as the channel length increases and the gate length (Lg) and the distance between adjacent levels (Ls) decrease due to the increased levels of memory cells. Program disturbance may be caused by various effects, including Fowler-Nordheim (FN) tunneling effect and hot carrier injection (HCl) effect. FN tunneling effect is a temperature-independent tunneling mechanism that can inject electrons into the gate of 3D NAND Flash memory during program operations when a high electric field (channel potential) exists between the source and the gate. On the other hand, if the channel potential at the select word line becomes too high because of the excessive natural local self-boosting when electrons are collected due to the potential difference, the HCl effect may occur in the channel. Both the FN tunneling effect and HCl effect can adversely affect the subsequent read operation, e.g., by increasing the failure bit count (FBC).

Thus, it is a common practice to add a bias to the voltage applied to the source of the memory strings in the program cycles of program operations to increase local boosting and reduce the channel potential between the source and the gate, thereby reducing the program disturbance caused by the FN tunneling effect. However, increasing the source voltage can increase the program disturbance caused by the HCl effect. Thus, the source bias needs to be carefully determined in view of both the FN tunneling effect and the HCl effect. Moreover, different from the FN tunneling effect, the HCl effect is temperature-dependent and becomes more severe as the temperature decreases since the lattice vibration of polysilicon (the channel material) is suppressed, while the electron energy increases, at a lower temperature. In other words, the balance between the FN tunneling effect and the HCl effect can be broken as the temperature changes.

To address one or more of the aforementioned issues, the present disclosure provides a temperature-dependent source/drain bias scheme that balances the FN tunneling effect and the HCl effect in view of the current temperature associated with the memory device. In some implementations, in the pre-charge period of a program operation, the bias voltage applied to the bit line and/or the source line varies based on the temperature associated with the memory device, instead of a constant value, thereby dynamically compensating the variation of HCl effect caused by the temperature changes. For example, the source bias and/or the drain bias may decrease as the temperature decreases.

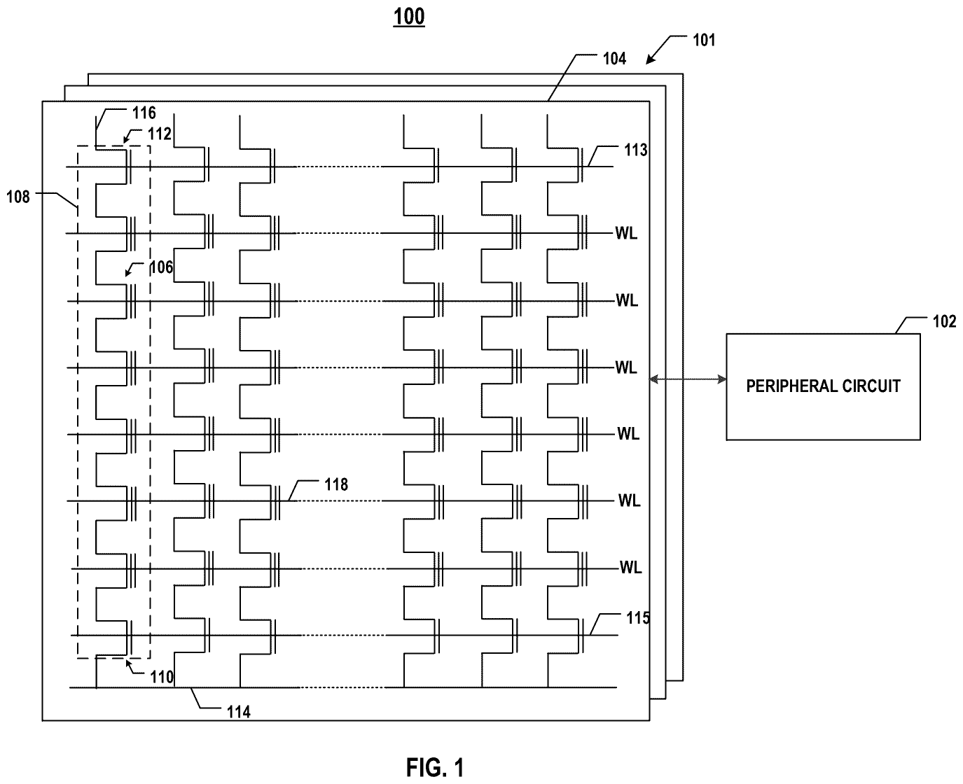

FIG. 1 illustrates a schematic circuit diagram of a memory device 100 including peripheral circuits, according to some aspects of the present disclosure. Memory device 100 can include a memory cell array 101 and peripheral circuits 102 coupled to memory cell array 101. Memory cell array 101 can be a NAND Flash memory cell array in which memory cells 106 are provided in the form of an array of NAND memory strings 108 each extending vertically above a substrate (not shown). In some implementations, each NAND memory string 108 includes a plurality of memory cells 106 coupled in series and stacked vertically. Each memory cell 106 can hold a continuous, analog value, such as an electrical voltage or charge, which depends on the number of electrons trapped within a region of memory cell 106. Each memory cell 106 can be either a floating gate type of memory cell including a floating-gate transistor or a charge trap type of memory cell including a charge-trap transistor.

In some implementations, each memory cell 106 is an SLC that has two possible levels (memory states) and thus, can store one bit of data. For example, the first level “0” can correspond to a first range of threshold voltages, and the second level “1” can correspond to a second range of threshold voltages. In some implementations, each memory cell 106 is an xLC that is capable of storing more than a single bit of data in more than four levels. For example, the xLC may store two bits per cell (MLC), three bits per cell (TLC), or four bits per cell (QLC)). Each xLC can be programmed to assume a range of possible nominal storage values (i.e., corresponding to 2^{N} pieces of N-bits data). In some implementations, at least one of memory cells 106 is set to one of 2^{N} levels corresponding to a piece of N-bits data, where N is an integer greater than 1.

As shown in FIG. 1, each NAND memory string 108 can also include a source select gate (SSG) transistor 110 (a.k.a., bottom select gate (BSG) transistor) at its source end and a drain select gate (DSG) transistor 112 (a.k.a., top select gate (TSG) transistor) at its drain end. SSG transistor 110 and DSG transistor 112 can be configured to activate select NAND memory strings 108 (columns of the array) during read and program operations. In some implementations, the sources of NAND memory strings 108 in the same block 104 are coupled through a same source line (SL) 114, e.g., a common SL. In other words, all NAND memory strings 108 in the same block 104 have an array common source (ACS), according to some implementations. The drain of each NAND memory string 108 is coupled to a respective bit line 116 from which data can be read or written via an output bus (not shown), according to some implementations. In some implementations, each NAND memory string 108 is configured to be selected or deselected by applying a select voltage (e.g., a positive voltage greater than the threshold voltage of DSG transistor 112) or a deselect voltage (e.g., the ground voltage) to the gate of respective DSG transistor 112 through one or more DSG lines 113 and/or by applying a select voltage (e.g., a positive voltage greater than the threshold voltage of SSG transistor 110) or a deselect voltage (e.g., the ground voltage) to the gate of respective SSG transistor 110 through one or more SSG lines 115.

As shown in FIG. 1, NAND memory strings 108 can be organized into multiple blocks 104, each of which can have a common source line 114, e.g., coupled to the ACS. In some implementations, each block 104 is the basic data unit for erase operations, i.e., all memory cells 106 on the same block 104 are erased at the same time. To erase memory cells 106 in a select block 104, source lines 114 coupled to select block 104 as well as unselect blocks 104 in the same plane as select block 104 can be biased with an erase voltage (Vers), such as a high positive bias voltage (e.g., 20 V or more). Memory cells 106 of adjacent NAND memory strings 108 can be coupled through word lines 118 that select which row of memory cells 106 is affected by read and program operations. In some implementations, each word line 118 is coupled to a plurality of memory cells 106. Each word line 118 can include a plurality of control gates (gate electrodes) at each memory cell 106 and a gate line coupling the control gates.

As shown in FIG. 1, memory cell array 101 can include an array of memory cells 106 in a plurality of rows and a plurality of columns in each block 104. One column of memory cells corresponds to one NAND memory string 108, according to some implementations. The plurality of rows of memory cells 106 can be respectively coupled to word lines 118, and the plurality of columns of memory cells 106 can be respectively coupled to bit lines 116. Peripheral circuit 102 can be coupled to memory cell array 101 through bit lines 116 and word lines 118.

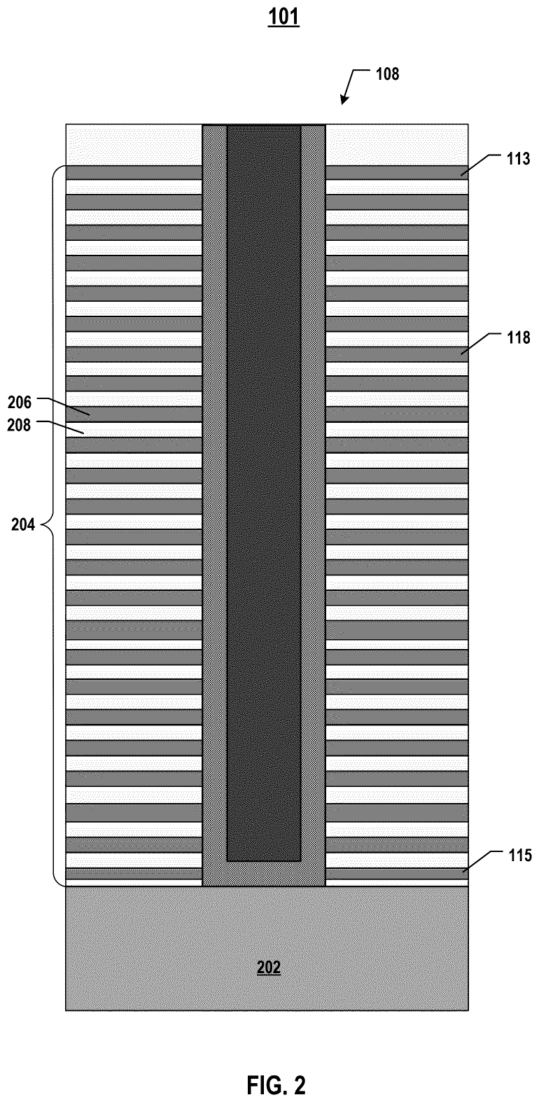

FIG. 2 illustrates a side view of a cross-section of memory cell array 101 including NAND memory string 108, according to some aspects of the present disclosure. As shown in FIG. 2, NAND memory string 108 can extend vertically through a memory stack 204 above a substrate 202. Substrate 202 can include silicon (e.g., single crystalline silicon), silicon germanium (SiGe), gallium arsenide (GaAs), germanium (Ge), silicon on insulator (SOI), germanium on insulator (GOI), or any other suitable materials.

Memory stack 204 can include interleaved gate conductive layers 206 and gate-to-gate dielectric layers 208. The number of the pairs of gate conductive layers 206 and gate-to-gate dielectric layers 208 in memory stack 204 can determine the number of memory cells 106 in memory cell array 101. Gate conductive layer 206 can include conductive materials including, but not limited to, tungsten (W), cobalt (Co), copper (Cu), aluminum (Al), polysilicon, doped silicon, silicides, or any combination thereof. In some implementations, each gate conductive layer 206 includes a metal layer, such as a tungsten layer. In some implementations, each gate conductive layer 206 includes a doped polysilicon layer. Each gate conductive layer 206 can include control gates surrounding memory cells 106, the gates of DSG transistors 112, or the gates of SSG transistors 110, and can extend laterally as DSG line 113 at the top of memory stack 204, SSG line 115 at the bottom of memory stack 204, or word line 118 between DSG line 113 and SSG line 115.

As shown in FIG. 2, NAND memory string 108 includes a channel structure extending vertically through memory stack 204. In some implementations, the channel structure includes a channel hole filled with semiconductor material(s), including polysilicon, (e.g., as a semiconductor channel) and dielectric material(s) (e.g., as a memory film). It is understood that although not shown in FIG. 2, additional components of memory cell array 101 can be formed including, but not limited to, gate line slits/source contacts, local contacts, interconnect layers, etc.

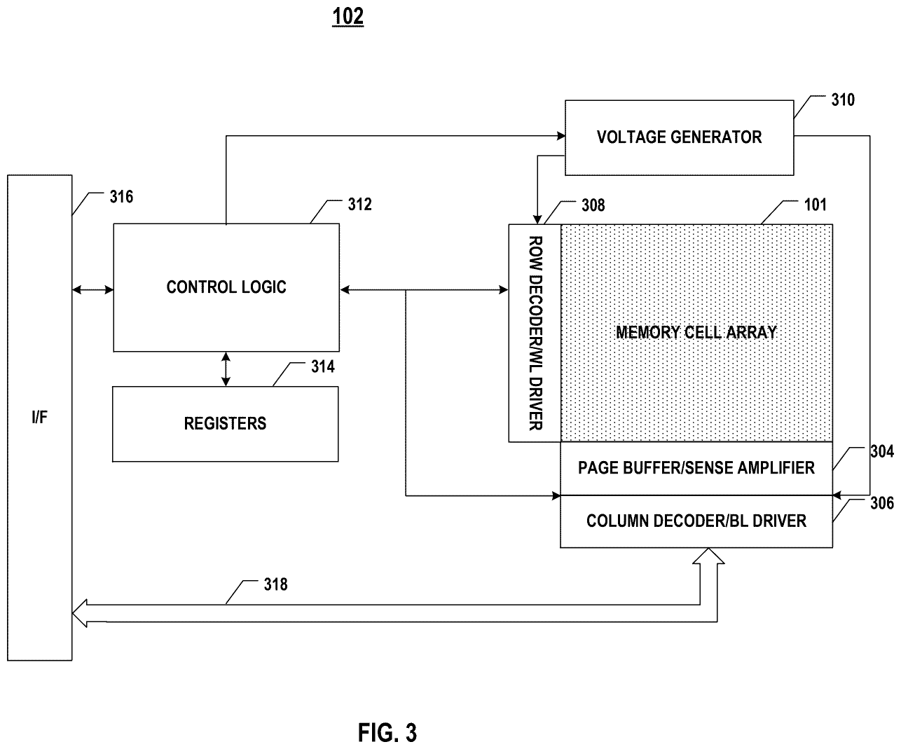

Referring back to FIG. 1, peripheral circuits 102 can be coupled to memory cell array 101 through bit lines 116, word lines 118, source lines 114, SSG lines 115, and DSG lines 113. Peripheral circuits 102 can include any suitable analog, digital, and mixed-signal circuits for facilitating the operations of memory cell array 101 by applying and sensing voltage signals and/or current signals to and from each select memory cell 106 through bit lines 116, word lines 118, source lines 114, SSG lines 115, and DSG lines 113. Peripheral circuits 102 can include various types of peripheral circuits formed using metal-oxide-semiconductor (MOS) technologies. For example, FIG. 3 illustrates some exemplary peripheral circuits including a page buffer/sense amplifier 304, a column decoder/bit line driver 306, a row decoder/word line driver 308, a voltage generator 310, control logic 312, registers 314, an interface (I/F) 316, and a data bus 318. It is understood that in some examples, additional peripheral circuits not shown in FIG. 3 may be included as well.

Page buffer/sense amplifier 304 can be configured to sense (read) and program (write) data from and to memory cell array 101 according to the control signals from control logic 312. In one example, page buffer/sense amplifier 304 may store one or more pages of program data (write data, referred to herein as “data page”) to be programmed. In another example, page buffer/sense amplifier 304 may verify programmed select memory cells 106 in each program/verify cycle in a program operation to ensure that the data has been properly programmed into memory cells 106 coupled to select word lines 118. In still another example, page buffer/sense amplifier 304 may also sense the low power signals from bit line 116 that represents a data bit stored in memory cell 106 and amplify the small voltage swing to recognizable logic levels in a read operation.

Column decoder/bit line driver 306 can be configured to be controlled by control logic 312 and select one or more NAND memory strings 108 by applying bit line voltages generated from voltage generator 310. Row decoder/word line driver 308 can be configured to be controlled by control logic 312 and select/deselect blocks 104 of memory cell array 101 and select/deselect word lines 118 of block 104. Row decoder/word line driver 308 can be further configured to drive word lines 118 using word line voltages generated from voltage generator 310. In some implementations, row decoder/word line driver 308 can also select/deselect and drive SSG lines 115 and DSG lines 113 as well. Voltage generator 310 can be configured to be controlled by control logic 312 and generate the word line voltages (e.g., read voltage, program voltage, channel pass voltage, local voltage, verify voltage, etc.), bit line voltages, and source line voltages to be supplied to memory cell array 101.

Control logic 312 can be coupled to each peripheral circuit described above and configured to control the operations of each peripheral circuit. Registers 314 can be coupled to control logic 312 and include status registers, command registers, and address registers for storing status information, command operation codes (OP codes), and command addresses for controlling the operations of each peripheral circuit. Interface 316 can be coupled to control logic 312 and act as a control buffer to buffer and relay control commands received from a memory controller (not shown) and/or a host (not shown) to control logic 312 and status information received from control logic 312 to the memory controller and/or the host. Interface 316 can also be coupled to column decoder/bit line driver 306 via data bus 318 and act as a data input/output (I/O) interface and a data buffer to buffer and relay the data to and from memory cell array 101.

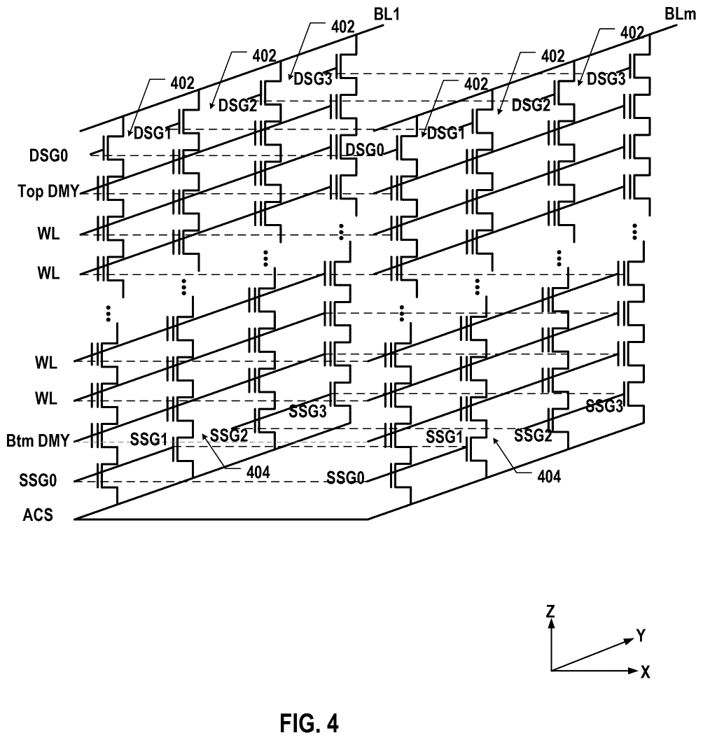

FIG. 4 illustrates a schematic diagram of 3D NAND memory strings, according to some aspects of the present disclosure. FIG. 4 shows an example of an array of 3D NAND memory strings (e.g., 108 in FIG. 1) in a block (e.g., 104 in FIG. 1). As shown in FIG. 4, from top to bottom in the z-direction, each 3D NAND memory string may be coupled to a number of lines in different rows, e.g., bit lines (BLs, e.g., 116 in FIG. 1), DSG lines (DSGs, e.g., 113 in FIG. 1), dummy DSG lines (top DMYs), word lines (WLs, e.g., 118 in FIG. 1), dummy SSG lines (bottom DMYs), SSG line (SSG, e.g., 115 in FIG. 1), and array common source line (ACS, e.g., 114 in FIG. 1). As shown in FIG. 4, in both the word line direction (the x-direction) and the bit line direction (the y-direction), the word lines may extend laterally to connect the memory cells of the 3D NAND memory strings. As to the DSG lines and SSG lines, the DSG lines and SSG lines may be continuous in the word line direction (the x-direction) to connect the DSG transistors and SSG transistors of the 3D NAND memory strings at the same position in the y-direction (e.g., DSG0 and DSG0, SSG0 and SSG0), but may be separated by DSG cuts 402 and SSG cuts 404 in the bit line direction (the y-direction) to form electrically-separated sets and fingers, respectively, which can be individually controlled in a program operation. It is understood that in program operations, the programming of the memory cells may be performed from the drain (e.g., DSGs) to the source (e.g., SSGs) (e.g., top to bottom as shown in FIG. 4) or from the source (e.g., SSGs) to the drain (e.g., DSGs) (e.g., bottom to top as shown in FIG. 4). As shown in FIG. 4, in the block, the DSG transistors of multiple 3D NAND memory strings may be coupled to multiple bit lines, respectively, while the SSG transistors of multiple 3D NAND memory strings may be coupled to the same source line (ACS).

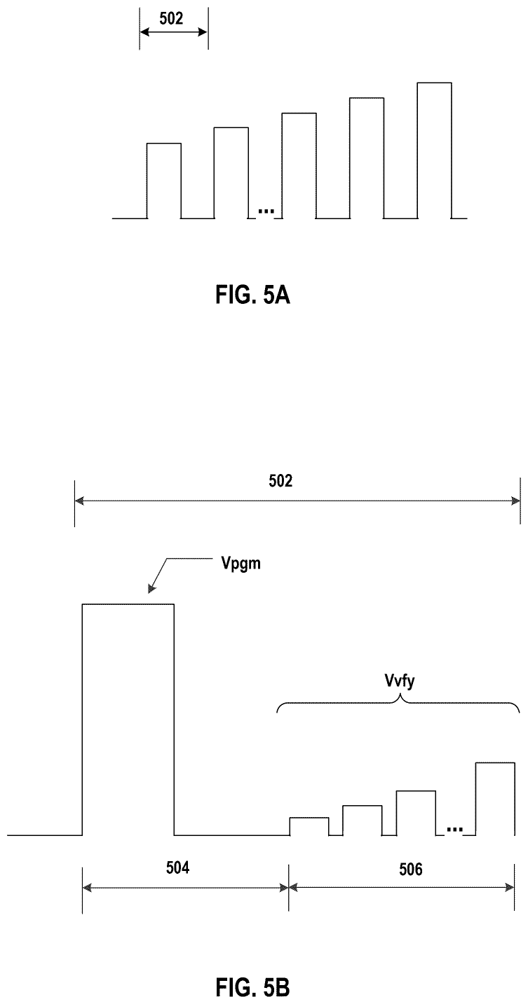

To perform a program operation, in addition to page buffer/sense amplifier 304 providing to each select memory cell 106 the corresponding piece of data, row decoder/word line driver 308 can be configured to apply program voltages and verify voltages to a select word line 118 coupled to a select row of memory cells 106 in one or more program/verify cycles in order to raise the threshold voltage of each select memory cell 106 to a desired level (into a desired range of threshold voltages) based on the corresponding piece of data. For example, FIGS. 5A and 5B illustrate a waveform of word line voltages applied to a select word line in a program operation, according to some aspects of the present disclosure.

As shown in FIGS. 5A and 5B, the program operation includes one or more loops 502, each of which includes a program cycle 504 and a verify cycle 506, according to some implementations. As shown in FIG. 5B, in each loop 502, row decoder/word line driver 308 can be configured to apply a program voltage (Vpgm) on select word line 118 to select row of memory cells 106 in program cycle 504 and sequentially apply one or more verify voltages (Vvfy) with incremental changes of voltage levels to verify select row of memory cells 106 in verify cycle 506. That is, in each loop 502, peripheral circuit 102 can perform verification of select row of memory cells 106 at one or more levels in verify cycle 506 after applying a program voltage in program cycle 504. The number of verify voltages applied in verify cycle 506 depends on the level being programmed by the specific loop 502, according to some implementations. As a result, at the end of the program operation, for example, select memory cell 106 may be programmed into one of the 2^{N} levels based on the corresponding N bits of data to be stored in select memory cell 106, where N is a positive integer.

In some implementations, the program operation is an incremental step pulse program (ISPP), which gradually increases the program voltage on a step-voltage basis in different loops 502. The magnitude of this “step” (e.g., the increase in magnitude of the program voltage in each loop 502 relative to the program voltage in the immediately previous loop 502) is known as the “pulse step height.” Consistent with the scope of the present disclosure, in some implementations, the program operation includes at least a first loop 502 and a second loop 502 after the first loop 502, and the first loop 502 and the second loop 502 are the starting loop and the ending loop of ISPP, respectively.

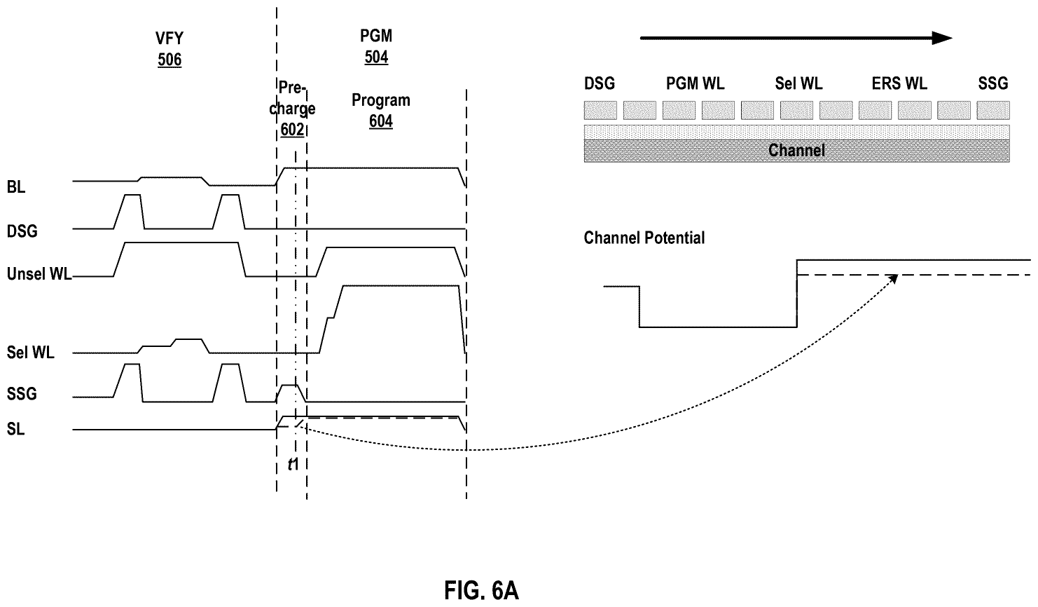

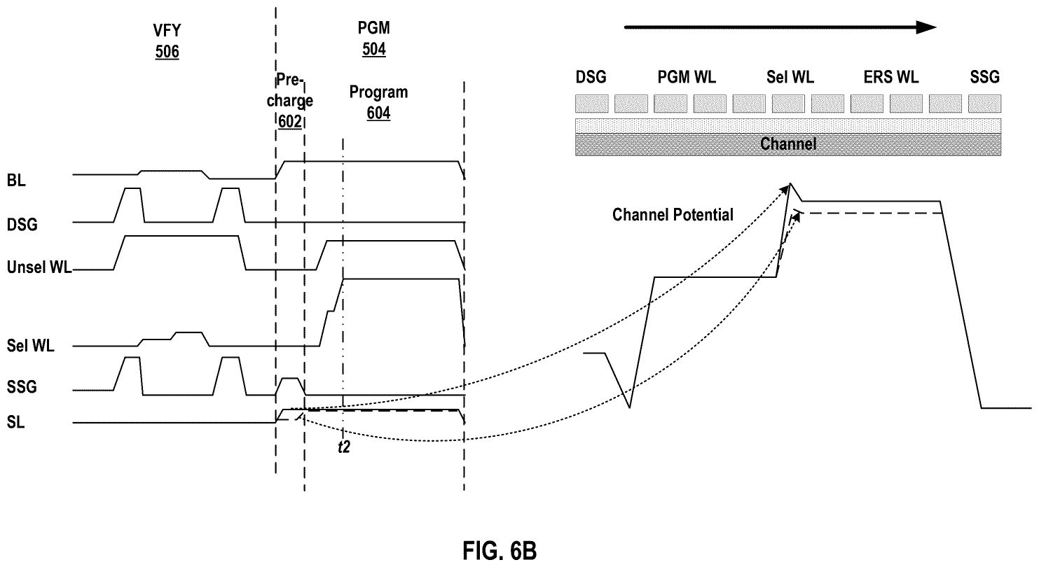

FIGS. 6A and 6B illustrate timing diagrams and channel potentials of NAND memory strings in a program operation, according to some aspects of the present disclosure. Although FIGS. 6A and 6B show one verify cycle 506 (VFY) and one program cycle 504 (PGM), it is understood that the program operation may include multiple verify cycles and multiple program cycles, for example, as shown in FIG. 5A. In verify cycle 506, one or more verify voltage pulses may be applied to the select word line (sel WL) to verify select memory cell coupled to the select word line at one or more levels. A pass voltage may be applied to each unselect word line (unsel WL) to turn on the unselect memory cells coupled to the unselect word lines. For an unselect NAND memory string, a deselect voltage (e.g., a ground voltage) may be applied to the DSG line (DSG) and the SSG line (SSG) to turn off the DSG transistor and the SSG transistor when applying the verify voltage pulses to the select word line to inhibit the verification of the unselect memory cells of the unselect NAND memory string in verify cycle 506.

The channel potential of the unselect NAND memory string may be first up-coupled to a positive potential in verify cycle 506, thereby causing HCl in the channel between the DSG transistor and SSG transistor. Thus, as shown in FIGS. 6A and 6B, before applying the verify voltage pulses to the select word line, a select (positive) voltage may be applied to the DSG line and SSG line to turn on the DSG transistor and SSG transistor in order to decrease the channel potential and reduce HCl before applying the verify voltage pulses, also known as “pre-pulse channel cleaning.” Similarly, the channel potential of the unselect NAND memory string may be down-coupled to a negative potential after applying the verify voltage pulses in verify cycle 506, causing HCl as well in the channel between the DSG transistor and SSG transistor. Thus, as shown in FIGS. 6A and 6B, after applying the verify voltage pulses, a select (positive) voltage may be applied to the DSG line and SSG line to turn on the DSG transistor and SSG transistor again in order to increase the channel potential and reduce HCl before program cycle 504, also known as “post-pulse channel cleaning.”

However, the channel potential may not be fully reset to the desired level after verify cycle 506. Thus, besides a program period (phase) 604 in which a program voltage is applied to the select word line to program the select memory cell, and a pass voltage is applied to each unselect word line to turn on the unselect memory cells, program cycle 504 includes a pre-charge period (phase) 602 immediately before program period 604 to help further “clean” the channel of the unselect NAND memory string and set the channel potential to the desired level before programming.

In the program operation shown in FIGS. 6A and 6B, the memory cells may be programmed in a direction from the DSG transistor to the SSG transistor (e.g., left to right as shown in FIGS. 6A and 6B). Thus, the unselect word lines between the DSG line (DSG) and the select word line (Sel WL) may be viewed as programmed word lines (PGM WL) since the memory cells coupled thereto have already been programmed, while the unselect word lines between the SSG line (SSG) and the select word line (Sel WL) may be viewed as erased word lines (ERS WL) since the memory cells coupled thereto have not been programmed yet (are still at the erased state).

As shown in FIGS. 6A and 6B, in pre-charge period 602 of program cycle 504, a select (positive) voltage may be applied to the SSG line to turn on the SSG transistor, and a bias (positive) voltage may be applied to the source line (SL) to pull electrons accumulated in the channel between the select memory cell and the source of the unselect NAND memory string. As a result, FN tunneling-induced program disturbance can be reduced by the bias voltage applied to the source line in pre-charge period 602.

FIG. 6A further shows the down-coupled negative channel potential along the channel at time 11 in pre-charge period 602. As shown in FIG. 6A, there is a significant potential difference between the select memory cell (coupled to Sel WL) and the immediately adjacent programmed memory cell (coupled to PGM WL left to Sel WL) at 11, which can cause HCl-induced program disturbance between the programmed memory cell and the select memory cell when programming the select memory cell. FIG. 6A also shows that reducing the bias voltage applied to the source line in pre-charge period 602 (represented by the dashed line) can reduce the potential difference (represented by the dashed line) at 11, thereby reducing the HCl-induced program disturbance. Thus, although FN tunneling-induced program disturbance can be reduced by the bias voltage applied to the source line in pre-charge period 602, the higher bias voltage may worsen the HCl-induced program disturbance.

Similarly, FIG. 6B shows the boosted channel potential along the channel at time 12 in program period 604. As shown in FIG. 6B, there is a significant potential difference between the select memory cell (coupled to Sel WL) and the immediately adjacent programmed memory cell (coupled to PGM WL left to Sel WL) at 12, which can cause HCl-induced program disturbance between the programmed memory cell and the select memory cell when programming the select memory cell. FIG. 6B also shows that reducing the bias voltage applied to the source line in pre-charge period 602 (represented by the dashed line) can also reduce the potential difference (represented by the dashed line) at 12, thereby reducing the HCl-induced program disturbance. Thus, although FN tunneling-induced program disturbance can be reduced by the bias voltage applied to the source line in pre-charge period 602 (a.k.a., local boosting), the higher bias voltage may worsen the HCl-induced program disturbance.

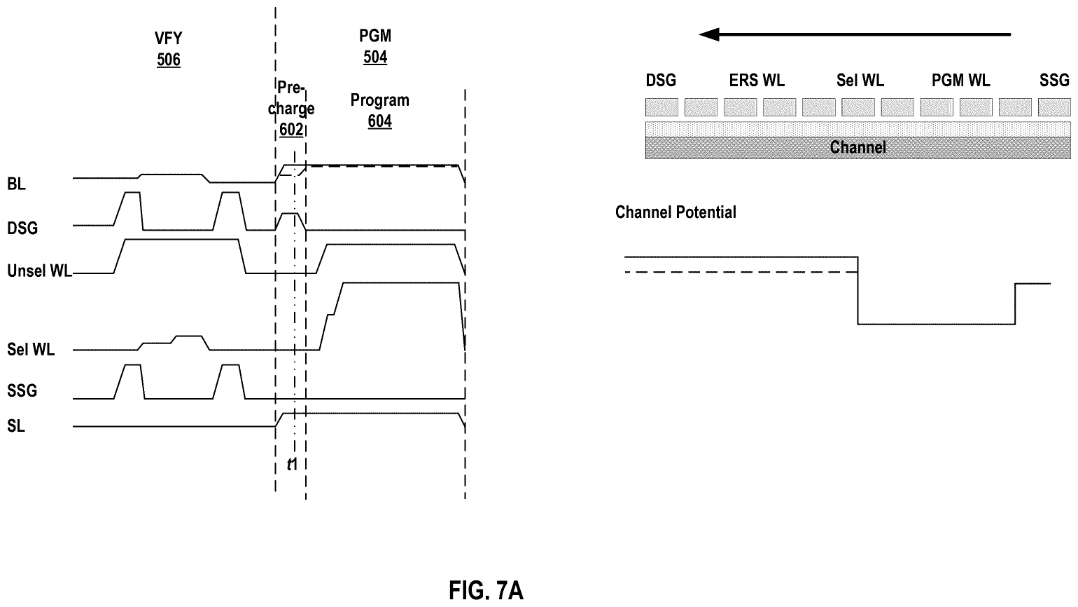

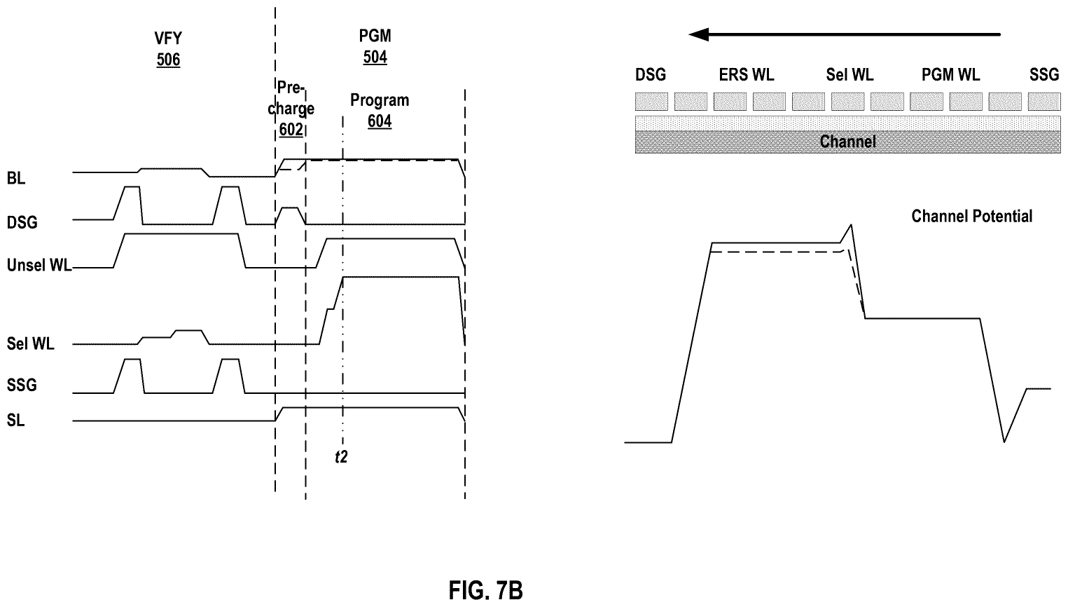

FIGS. 7A and 7B illustrate timing diagrams and channel potentials of NAND memory strings in another program operation, according to some aspects of the present disclosure. In the program operation shown in FIGS. 7A and 7B, the memory cells may be programmed in a direction from the SSG transistor to the DSG transistor (e.g., right to left as shown in FIGS. 7A and 7B). Thus, the unselect word lines between the SSG line (SSG) and the select word line (Sel WL) may be viewed as programmed word lines (PGM WL) since the memory cells coupled thereto have already been programmed, while the unselect word lines between the DSG line (DSG) and the select word line (Sel WL) may be viewed as erased word lines (ERS WL) since the memory cells coupled thereto have not been programmed yet (are still at the erased state).

As shown in FIGS. 7A and 7B, in pre-charge period 602 of program cycle 504, a select (positive) voltage may be applied to the DSG line to turn on the DSG transistor, and a bias (positive) voltage may be applied to the bit line (BL) to pull electrons accumulated in the channel between the select memory cell and the drain of the unselect NAND memory string. As a result, FN tunneling-induced program disturbance can be reduced by the bias voltage applied to the bit line in pre-charge period 602.

FIG. 7A further shows the down-coupled negative channel potential along the channel at time 11 in pre-charge period 602. As shown in FIG. 7A, there is a significant potential difference between the select memory cell (coupled to Sel WL) and the immediately adjacent programmed memory cell (coupled to PGM WL right to Sel WL) at 11, which can cause HCl-induced program disturbance between the programmed memory cell and the select memory cell when programming the select memory cell. FIG. 7A also shows that reducing the bias voltage applied to the bit line in pre-charge period 602 (represented by the dashed line) can reduce the potential difference (represented by the dashed line) at 11, thereby reducing the HCl-induced program disturbance. Thus, although FN tunneling-induced program disturbance can be reduced by the bias voltage applied to the bit line in pre-charge period 602, the higher bias voltage may worsen the HCl-induced program disturbance.

Similarly, FIG. 7B shows the boosted channel potential along the channel at time 12 in program period 604. As shown in FIG. 7B, there is a significant potential difference between the select memory cell (coupled to Sel WL) and the immediately adjacent programmed memory cell (coupled to PGM WL right to Sel WL) at 12, which can cause HCl-induced program disturbance between the programmed memory cell and the select memory cell when programming the select memory cell. FIG. 7B also shows that reducing the bias voltage applied to the bit line in pre-charge period 602 (represented by the dashed line) can also reduce the potential difference (represented by the dashed line) at 12, thereby reducing the HCl-induced program disturbance. Thus, although FN tunneling-induced program disturbance can be reduced by the bias voltage applied to the bit line in pre-charge period 602 (a.k.a., local boosting), the higher bias voltage may worsen the HCl-induced program disturbance.

Moreover, although FN tunneling-induced program disturbance is temperature-independent, HCl-induced program disturbance can be worsened as the temperature reduces since the lattice vibration of polysilicon (the channel material) is suppressed, while the electron energy increases, at a lower temperature, regardless of source line local boosting or bit line local boosting in pre-charge period 602.

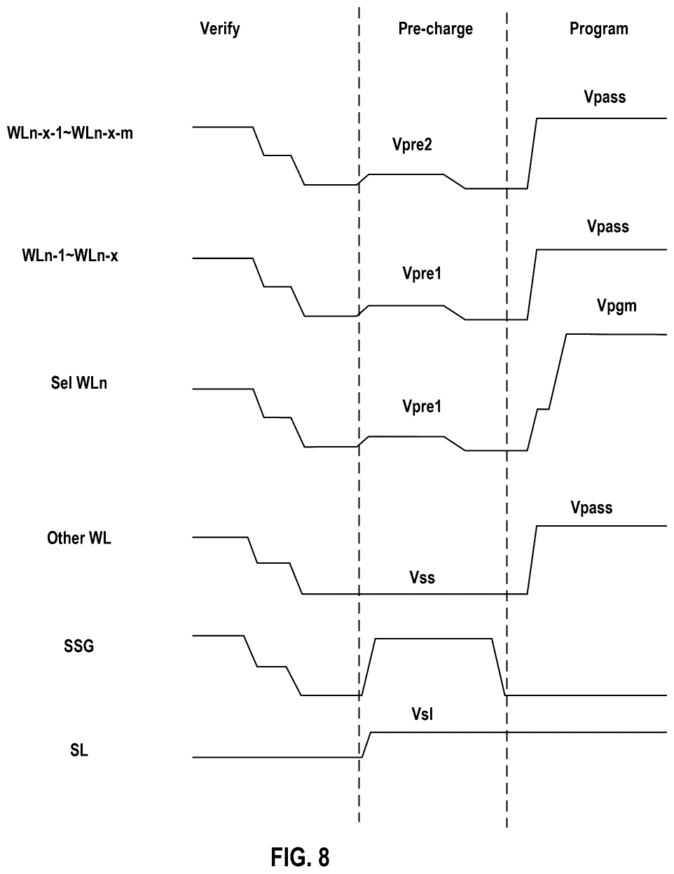

For example, FIG. 8 illustrates timing diagrams of a program operation. The memory cells are programmed in a direction from the DSG transistor to the SSG transistor. In the pre-charge period of the program cycle of the program operation, a select voltage (e.g., a positive voltage) is applied to the SSG line (SSG) to turn on the SSG transistor in the NAND memory string. In the pre-charge period, a source bias voltage (Vs1, e.g., a positive voltage) is applied to the source line (SL) as well. Pre-charge voltages (Vpre1 and Vpre2, e.g., positive voltages) are applied to the select word line (Sel WLn) and its adjacent unselect word lines (WLn-1-WLn-x and WLn-x-1-WLn-x-m), and a source supply voltage (Vss, e.g., a ground voltage) is applied to other unselect word lines. As a result, electrons accumulated in the channel between the select memory cell and the source of the NAND memory string can be pulled out from the source in the pre-charge period.

In the program period of the program cycle of the program operation, a source supply voltage (Vss, e.g., a ground voltage) is applied to the SSG line to turn off the SSG transistor, and the source bias voltage is kept at the source line. In the program period, a program voltage (Vpgm) is applied to the select word line to program the select memory cell coupled to the select word line, and a pass voltage (Vpass) is applied to each unselect word line to turn on the unselect memory cells coupled to the unselect word lines.

As shown in FIG. 8, in this example, the source bias voltage is maintained at the same level through the pre-charge period and the program period of the program cycle. Further, regardless of the current temperature associated with the memory device, the source line bias voltage also remains at the same level in different pre-charge periods of a program operation or in different program operations.

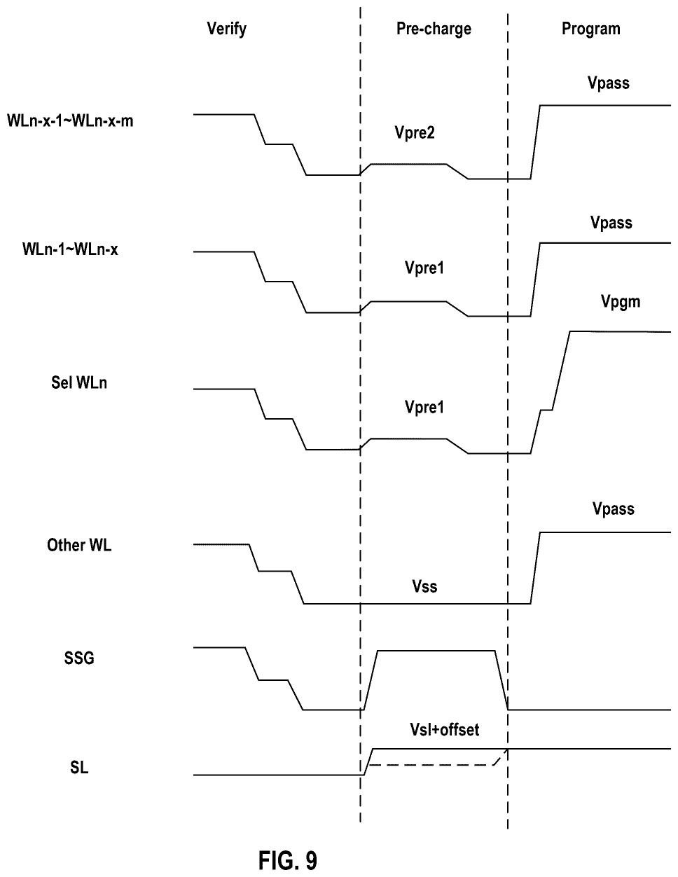

In contrast, a temperature-dependent source/drain bias scheme that balances the FN tunneling effect and the HCl effect in view of the current temperature associated with the memory device is provided in the present disclosure to further reduce the program disturbance in program operations. FIG. 9 illustrates timing diagrams of a program operation, according to some aspects of the present disclosure. Peripheral circuit 102 can be configured to program the memory cells in a direction from DSG transistor 112 to SSG transistor 110. As shown in FIG. 9, in a pre-charge period of the program operation, word line driver 308 of peripheral circuit 102 can be configured to turn on SSG transistor 110 by applying a select voltage (e.g., a positive voltage higher than the threshold voltage of SSG transistor 110) to SSG line 115 (SSG). Although the pre-charge period in FIG. 9 is immediately after a verify cycle of the program operation, it is understood that in some examples, the pre-charge period may be in a first loop of a program operation without any preceding verify cycle in the same program operation.

As shown in FIG. 9, in the pre-charge period, word line driver 308 of peripheral circuit 102 can be further configured to apply a source bias voltage (Vsl+offset, represented by the dashed line, e.g., a positive voltage) to source line 114 (SL). The source bias voltage can be determined, for example, by control logic 312 of peripheral circuit 102, based on the temperature associated with memory device 100. In some implementations, the source bias voltage includes a baseline voltage (Vsl, represented by the solid line) and an offset. For example, the baseline voltage may be a constant value, while the offset may be dynamically adjusted based on the temperature associated with memory device 100 to compensate for the HCl effect in real-time. In some implementations, the baseline voltage is set at a certain temperature, which can be a relatively high temperature that has little impact on the HCl effect, such as 85 degrees Celsius. For example, the offset may be 0 at 85 degrees Celsius.

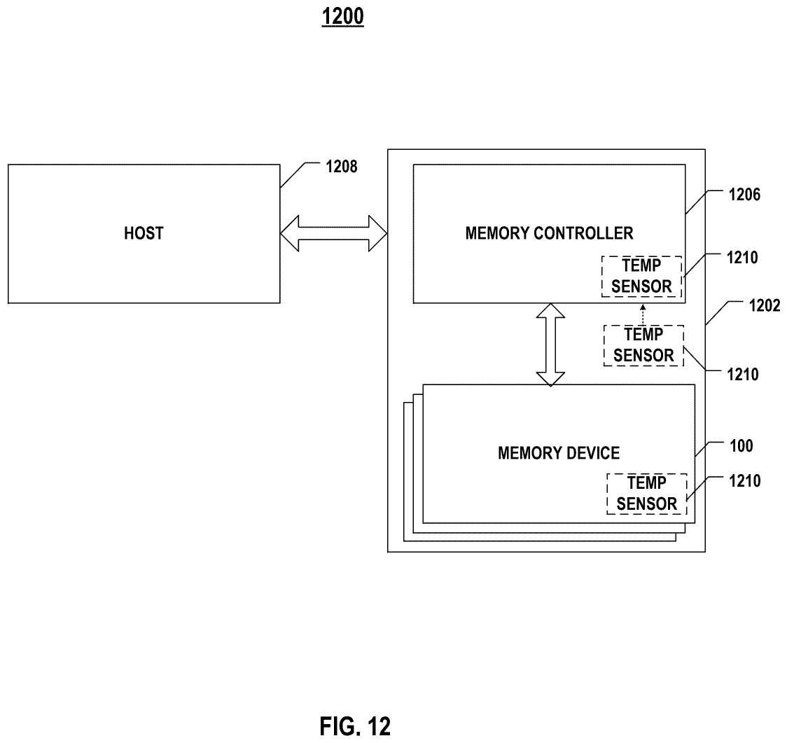

Control logic 312 of peripheral circuit 102 can be configured to obtain the temperature associated with memory device 100, and determine the source bias voltage based on the temperature. The temperature can be obtained using one or more temperature sensors, for example, as described below in detail with respect to FIG. 12. In some implementations, the temperature includes a first temperature and a second temperature lower than the first temperature, and the source bias voltage includes a first source bias voltage at the first temperature and a second source bias voltage at the second temperature that is lower than the first source bias voltage. That is, the source bias voltage can be decreased as the temperature decreases, such that the HCl-induced program disturbance at a lower temperature can be further suppressed. For example, the decrease of the source bias voltage may be achieved by maintaining the same baseline voltage while increasing a negative offset as the temperature decreases. In some implementations, the difference between the first and second source bias voltages (e.g., the offset) is determined based on the difference between the first and second temperatures and a temperature coefficient. For example, the source bias voltage may be determined by σ*(V₁-V₂)/(T₁-T₂), where σ is the temperature coefficient, and V₁, V₂, T₁, and T₂ are the first source bias voltage, second source bias voltage, first temperature, and second temperature, respectively. In some implementations, the temperature coefficient is a constant, meaning that the offset has a linear relationship with the temperature changes.

In some implementations, word line driver 308 of peripheral circuit 102 is configured to apply pre-charge voltages (Vpre1 and Vpre2, e.g., positive voltages) to the select word line (Sel WLn) and its adjacent unselect word lines (WLn-1-WLn-x and WLn-x-1-WLn-x-m), and apply a source supply voltage (Vss, e.g., a ground voltage) to other unselect word lines. It is understood that in other examples, different pre-charge voltages or a source supply voltage may be applied to the select word line and/or its adjacent unselect word lines.

As shown in FIG. 9, in the program period immediately after the pre-charge period of the program operation, word line driver 308 of peripheral circuit 102 can be configured to apply a source supply voltage (Vss, e.g., a ground voltage) to SSG line 115 to turn off SSG transistor 110. In some implementations, in the program period, word line driver 308 of peripheral circuit 102 is further configured to apply the baseline voltage (without the offset) on source line 114. That is, the offset is applied to the source bias voltage in the pre-charge period, but not in the program period, such that word line driver 308 charges source line 114 back to the baseline voltage in the program period, according to some implementations. In the program period, word line driver 308 of peripheral circuit 102 can be configured to apply a program voltage (Vpgm) to the select word line to program the select memory cell, and apply a pass voltage (Vpass) to each unselect word line to turn on the unselect memory cells.

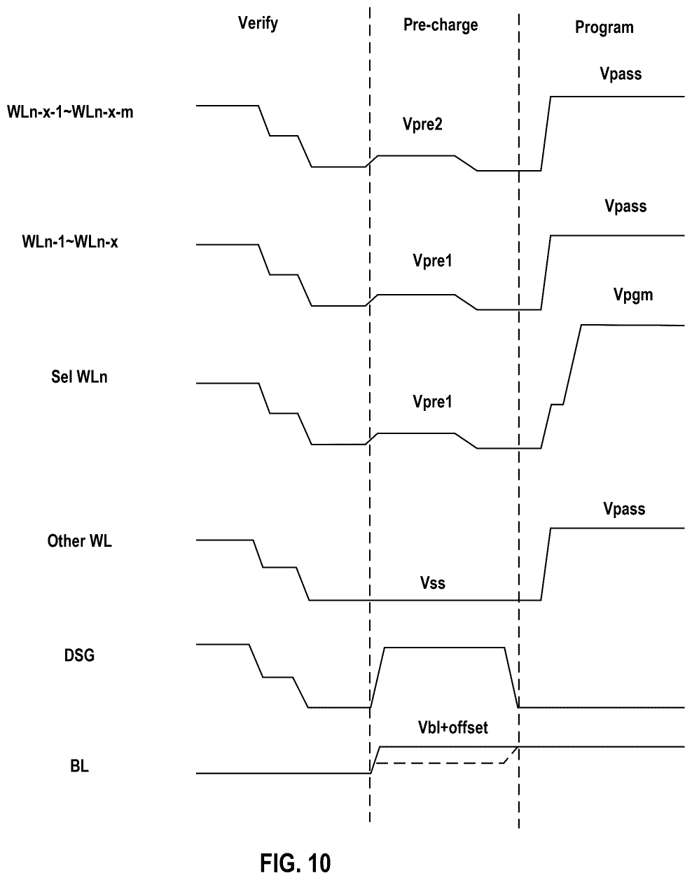

FIG. 10 illustrates timing diagrams of another program operation, according to some aspects of the present disclosure. Peripheral circuit 102 can be configured to program the memory cells in a direction from SSG transistor 110 to DSG transistor 112. As shown in FIG. 10, in a pre-charge period of the program operation, word line driver 308 of peripheral circuit 102 can be configured to turn on DSG transistor 112 by applying a select voltage (e.g., a positive voltage higher than the threshold voltage of DSG transistor 112) to DSG line 113 (DSG). Although the pre-charge period in FIG. 10 is immediately after a verify cycle of the program operation, it is understood that in some examples, the pre-charge period may be in a first loop of a program operation without any preceding verify cycle in the same program operation.

As shown in FIG. 10, in the pre-charge period, page buffer 304 of peripheral circuit 102 can be further configured to apply a drain bias voltage (Vbl+offset, represented by the dashed line, e.g., a positive voltage) to bit line 116 (BL). The drain bias voltage can be determined, for example, by control logic 312 of peripheral circuit 102, based on the temperature associated with memory device 100. In some implementations, the drain bias voltage includes a baseline voltage (Vbl, represented by the solid line) and an offset. For example, the baseline voltage may be a constant value, while the offset may be dynamically adjusted based on the temperature associated with memory device 100 to compensate for the HCl effect in real-time. In some implementations, the baseline voltage is set at a certain temperature, which can be a relatively high temperature that has little impact on the HCl effect, such as 85 degrees Celsius. For example, the offset may be 0 at 85 degrees Celsius.

Control logic 312 of peripheral circuit 102 can be configured to obtain the temperature associated with memory device 100, and determine the drain bias voltage based on the temperature. The temperature can be obtained using one or more temperature sensors, for example, as described below in detail with respect to FIG. 12. In some implementations, the temperature includes a first temperature and a second temperature lower than the first temperature, and the drain bias voltage includes a first drain bias voltage at the first temperature and a second drain bias voltage at the second temperature that is lower than the first drain bias voltage. That is, the drain bias voltage can be decreased as the temperature decreases, such that the HCl-induced program disturbance at a lower temperature can be further suppressed. For example, the decrease of the drain bias voltage may be achieved by maintaining the same baseline voltage while increasing a negative offset as the temperature decreases. In some implementations, the difference between the first and second drain bias voltages (e.g., the offset) is determined based on the difference between the first and second temperatures and a temperature coefficient. For example, the drain bias voltage may be determined by σ*(V₁-V₂)/(T₁-T₂), where σ is the temperature coefficient, and V₁, V₂, T₁, and T₂ are the first drain bias voltage, second drain bias voltage, first temperature, and second temperature, respectively. In some implementations, the temperature coefficient is a constant, meaning that the offset has a linear relationship with the temperature changes.

In some implementations, word line driver 308 of peripheral circuit 102 is configured to apply pre-charge voltages (Vpre1 and Vpre2, e.g., positive voltages) to the select word line (Sel WLn) and its adjacent unselect word lines (WLn-1-WLn-x and WLn-x-1-WLn-x-m), and apply a source supply voltage (Vss, e.g., a ground voltage) to other unselect word lines, which are coupled to memory cells that are inhibited. It is understood that in other examples, different pre-charge voltages or a source supply voltage may be applied to the select word line and/or its adjacent unselect word lines.

As shown in FIG. 10, in the program period immediately after the pre-charge period of the program operation, word line driver 308 of peripheral circuit 102 can be configured to apply a source supply voltage (Vss, e.g., a ground voltage) to DSG line 113 to turn off DSG transistor 112. In some implementations, in the program period, word line driver 308 of peripheral circuit 102 is further configured to apply the baseline voltage (without the offset) on bit line 116. That is, the offset is applied to the drain bias voltage in the pre-charge period, but not in the program period, such that word line driver 308 charges bit line 116 back to the baseline voltage in the program period, according to some implementations. In the program period, word line driver 308 of peripheral circuit 102 can be configured to apply a program voltage (Vpgm) to the select word line to program the select memory cell, and apply a pass voltage (Vpass) to each unselect word line to turn on the unselect memory cells.

Although not shown in FIGS. 9 and 10, it is understood that in some examples, both the source bias voltage and the drain bias voltage described above with respect to FIGS. 9 and 10 separately may be applied to source line 114 and bit line 116 in the same pre-charge period, and both SSG transistor 110 and DSG transistor 112 may be turned on in the same pre-charge period as well.

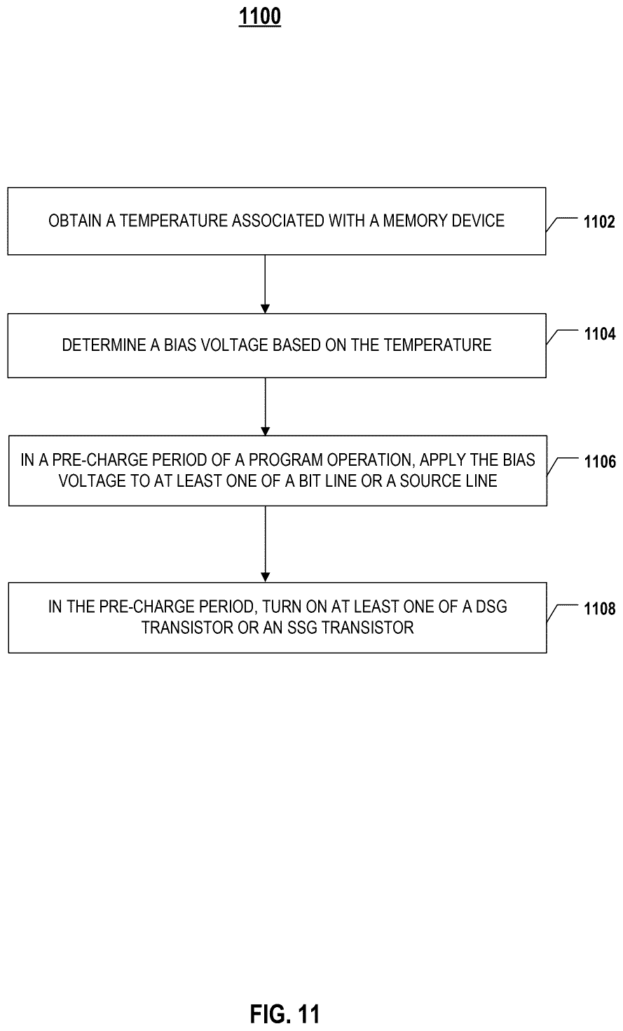

FIG. 11 illustrates a flowchart of a method 1100 for programming a memory device, according to some aspects of the present disclosure. The memory device may be any suitable memory device disclosed herein, such as memory device 100. Method 1100 may be implemented by peripheral circuit 102, such as row decoder/word line driver 308, page buffer/sense amplifier 304, and control logic 312. It is understood that the operations shown in method 1100 may not be exhaustive and that other operations can be performed as well before, after, or between any of the illustrated operations. Further, some of the operations may be performed simultaneously, or in a different order than shown in FIG. 11.

Referring to FIG. 11, method 1100 starts at operation 1102, in which a temperature associated with a memory device is obtained. Method 1100 proceeds to operation 1104, as illustrated in FIG. 11, in which the bias voltage is determined based on the temperature. In some implementations, the temperature includes a first temperature and a second temperature lower than the first temperature, and the bias voltage includes a first bias voltage at the first temperature and a second bias voltage at the second temperature that is lower than the first bias voltage. In some implementations, the difference between the first and second bias voltages is determined based on the difference between the first and second temperatures and a temperature coefficient, for example, a constant.

Method 1100 proceeds to operation 1106, as illustrated in FIG. 11, in which, in a pre-charge period of a program operation, a bias voltage is applied to at least one of the bit line or the source line. In one example, as shown in FIG. 9 in which the memory cells are programmed in a direction from DSG transistor 112 to SSG transistor 110, a source bias voltage (Vsl+offset), which is determined based on the current temperature associated with memory device 100, may be applied to source line (SL) 114 in the pre-charge period by word line driver 308 of peripheral circuit 102. In another example, as shown in FIG. 10 in which the memory cells are programmed in a direction from SSG transistor 110 to DSG transistor 112, a drain bias voltage (Vbl+offset), which is determined based on the current temperature associated with memory device 100, may be applied to bit line (BL) 116 in the pre-charge period by word line driver 308 of peripheral circuit 102.

Method 1100 proceeds to operation 1108, as illustrated in FIG. 11, in which, in the pre-charge period, at least one of a DSG transistor or an SSG transistor is turned on. In one example, as shown in FIG. 9 in which the memory cells are programmed in a direction from DSG transistor 112 to SSG transistor 110, a select voltage (e.g., a positive voltage higher than the threshold voltage) may be applied to SSG line (SSG) 115 by word line driver 308 of peripheral circuit 102 to turn on SSG transistor 110 in the pre-charge period. In another example, as shown in FIG. 10 in which the memory cells are programmed in a direction from SSG transistor 110 to DSG transistor 112, a select voltage (e.g., a positive voltage higher than the threshold voltage) may be applied to DSG line (DSG) 113 by word line driver 308 of peripheral circuit 102 to turn on DSG transistor 112 in the pre-charge period. Although not shown in FIGS. 9 and 10, it is understood that in some examples, both the source bias voltage and the drain bias voltage may be applied to source line 114 and bit line 116 in the same pre-charge period, and both SSG transistor 110 and DSG transistor 112 may be turned on in the same pre-charge period as well.

FIG. 12 illustrates a block diagram of a system 1200 having a memory device, according to some aspects of the present disclosure. System 1200 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 12, system 1200 can include a host 1208 and a memory system 1202 having one or more memory devices 100 (shown in FIG. 1) and a memory controller 1206. Host 1208 can be a processor of an electronic device, such as a central processing unit (CPU), or a system-on-chip (SoC), such as an application processor (AP). Host 1208 can be configured to send or receive data to or from memory devices 100.

Memory device 100 can be any memory device disclosed in the present disclosure, such as 3D NAND Flash memory devices. Memory controller 1206 is coupled to memory device 100 and host 1208 and is configured to control memory device 100, according to some implementations. Memory controller 1206 can manage the data stored in memory device 100 and communicate with host 1208. In some implementations, memory controller 1206 is designed for operating in a low duty-cycle environment like secure digital (SD) cards, compact Flash (CF) cards, universal serial bus (USB) Flash drives, or other media for use in electronic devices, such as personal computers, digital cameras, mobile phones, etc. In some implementations, memory controller 1206 is designed for operating in a high duty-cycle environment SSDs or embedded multi-media-cards (eMMCs) used as data storage for mobile devices, such as smartphones, tablets, laptop computers, etc., and enterprise storage arrays. Memory controller 1206 can be configured to control operations of memory device 100, such as read, erase, and program operations. Memory controller 1206 can also be configured to manage various functions with respect to the data stored or to be stored in memory device 100 including, but not limited to bad-block management, garbage collection, logical-to-physical address conversion, wear leveling, etc. In some implementations, memory controller 1206 is further configured to process error correction codes (ECCs) with respect to the data read from or written to memory device 100. Any other suitable functions may be performed by memory controller 1206 as well, for example, formatting memory device 100. Memory controller 1206 can communicate with an external device (e.g., host 1208) according to a particular communication protocol. For example, memory controller 1206 may communicate with the external device through at least one of various interface protocols, such as a USB protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc.

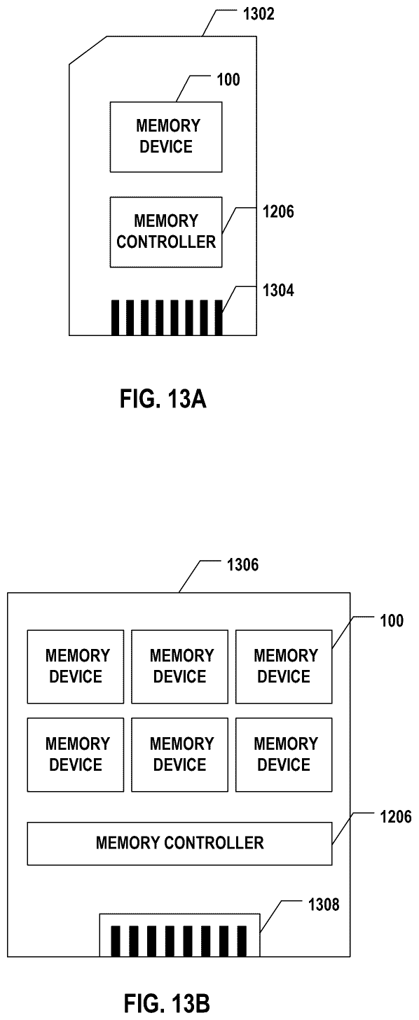

Memory controller 1206 and one or more memory devices 100 can be integrated into various types of storage devices, for example, being included in the same package, such as a universal Flash storage (UFS) package or an eMMC package. That is, memory system 1202 can be implemented and packaged into different types of end electronic products. In one example as shown in FIG. 13A, memory controller 1206 and a single memory device 100 may be integrated into a memory card 1302. Memory card 1302 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. Memory card 1302 can further include a memory card connector 1304 coupling memory card 1302 with a host (e.g., host 1208 in FIG. 12). In another example as shown in FIG. 3B, memory controller 1206 and multiple memory devices 100 may be integrated into an SSD 1306. SSD 1306 can further include an SSD connector 1308 coupling SSD 1306 with a host (e.g., host 1208 in FIG. 12). In some implementations, the storage capacity and/or the operation speed of SSD 1306 is greater than those of memory card 1302.

Referring back to FIG. 12, consistent with the scope of the present disclosure, memory system 1202 can also include one or more temperature sensors 1210 configured to measure the temperatures associated with memory device 100. Temperature sensors 1210 can be any suitable type, such as negative temperature coefficient (NTC) thermistors, thermocouples, resistance temperature detectors (RTDs), semiconductor-based temperature sensors, etc. As shown in FIG. 12, temperature sensor 1210 can be integrated to or disposed on memory controller 1206, integrated to or disposed on memory device 100, and/or separated from memory controller 1206 and memory device 100 within the package of memory system 1202. In some implementations, temperature sensor 1210 is integrated to or disposed on memory device 100 and configured to measure the temperature of memory device 100 directly. The measured temperature can be transmitted to memory controller 1206. In some implementations, temperature sensor 1210 is integrated to or disposed on memory controller 1206 and configured to measure the temperature of memory controller 1206 directly. The temperature of memory controller 1206 can be converted to the temperature of memory device 100 based on, for example, the distance between memory controller 1206 and memory device 100, the thermal conductivity of the medium between memory controller 1206 and memory device 100, and the volume of the package enclosing memory controller 1206 and memory device 100. In some implementations, temperature sensor 1210 is a standalone component separate from memory controller 1206 and memory device 100 and configured to measure the ambient temperature within the package of memory system 1202. The measured temperature can be transmitted to memory controller 1206 as well. Likewise, the ambient temperature can be converted to the temperature of memory device 100 based on, for example, the distance between temperature sensor 1210 and memory device 100, the thermal conductivity of the medium between temperature sensor 1210 and memory device 100, and the volume of the package enclosing memory controller 1206 and memory device 100. In any event, one or more temperature sensors 1210 can provide temperatures associated with different parts of memory system 1202 to memory controller 1206, such that memory controller 1206 can obtain the temperature associated with memory device 100. It is understood that in some examples, temperature sensors 1210 can provide the measurements to host 1208 directly, such that host 1208 can obtain the temperature associated with memory device 100.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations, but should be defined only in accordance with the following claims and their equivalents.

Although specific configurations and arrangements are discussed, it should be understood that this is done for illustrative purposes only. As such, other configurations and arrangements can be used without departing from the scope of the present disclosure. Also, the subject matter as described in the present disclosure can also be used in a variety of other applications. Functional and structural features as described in the present disclosures can be combined, adjusted, modified, and rearranged with one another and in ways that are consistent with the scope of the present disclosure.

What is claimed is:

1. A memory device, comprising:
a memory string comprising a drain select gate (DSG) transistor, memory cells, and a source select gate (SSG) transistor;
a bit line coupled to the DSG transistor;
a source line coupled to the SSG transistor; and
a peripheral circuit coupled to the memory string through the bit line and the source line, and configured to, in a pre-charge period of a program operation, apply a bias voltage to at least one of the bit line or the source line, wherein the bias voltage is determined based on a temperature associated with the memory device.

2. The memory device of claim 1, wherein
the temperature comprises a first temperature and a second temperature lower than the first temperature; and
the bias voltage comprises a first bias voltage at the first temperature and a second bias voltage at the second temperature that is lower than the first bias voltage.

3. The memory device of claim 2, wherein a difference between the first and second bias voltages is determined based on a difference between the first and second temperatures and a temperature coefficient.

4. The memory device of claim 3, wherein the temperature coefficient is a constant.

5. The memory device of claim 1, wherein the peripheral circuit is configured to:
program the memory cells in a direction from the DSG transistor to the SSG transistor; and
in the pre-charge period, apply the bias voltage to the source line.

6. The memory device of claim 5, wherein the peripheral circuit is further configured to, in the pre-charge period, turn on the SSG transistor.

7. The memory device of claim 1, wherein the peripheral circuit is configured to:
program the memory cells in a direction from the SSG transistor to the DSG transistor; and
in the pre-charge period, apply the bias voltage to the bit line.

8. The memory device of claim 7, wherein the peripheral circuit is further configured to, in the pre-charge period, turn on the DSG transistor.

9. The memory device of claim 1, wherein the peripheral circuit is further configured to:
obtain the temperature associated with the memory device; and
determine the bias voltage based on the temperature.

10. The memory device of claim 1, wherein
the memory string comprises a plurality of memory strings each comprising a DSG transistor, memory cells, and an SSG transistor;
the bit line comprises a plurality of bit lines coupled to the DSG transistors, respectively; and
the source line is coupled to the SSG transistors.

11. A method for operating a memory device, the memory device comprising a memory string comprising a drain select gate (DSG) transistor coupled to a bit line, memory cells, and a source select gate (SSG) transistor coupled to a source line, the method comprising:
in a pre-charge period of a program operation, applying a bias voltage to at least one of the bit line or the source line, wherein the bias voltage is determined based on a temperature associated with the memory device.

12. The method of claim 11, wherein
the temperature comprises a first temperature and a second temperature lower than the first temperature; and
the bias voltage comprises a first bias voltage at the first temperature and a second bias voltage at the second temperature that is lower than the first bias voltage.

13. The method of claim 12, wherein a difference between the first and second bias voltages is determined based on a difference between the first and second temperatures and a temperature coefficient.

14. The method of claim 13, wherein the temperature coefficient is a constant.

15. The method of claim 11, further comprising:
programming the memory cells in a direction from the DSG transistor to the SSG transistor; and
in the pre-charge period, applying the bias voltage to the source line.

16. The method of claim 15, further comprising, in the pre-charge period, turning on the SSG transistor.

17. The method of claim 11, further comprising:
programming the memory cells in a direction from the SSG transistor to the DSG transistor; and
in the pre-charge period, applying the bias voltage to the bit line.

18. The method of claim 17, further comprising, in the pre-charge period, turning on the DSG transistor.

19. The method of claim 11, further comprising:
obtaining the temperature associated with the memory device; and
determining the bias voltage based on the temperature.

20. A system, comprising:
a memory device, comprising:
a memory string comprising a drain select gate (DSG) transistor, memory cells, and a source select gate (SSG) transistor;
a bit line coupled to the DSG transistor;
a source line coupled to the SSG transistor; and
a peripheral circuit coupled to the memory string through the bit line and the source line, and configured to, in a pre-charge period of a program operation, apply a bias voltage to at least one of the bit line or the source line, wherein the bias voltage is determined based on a temperature associated with the memory device; and
a memory controller coupled to the memory device and configured to control the memory device.
